(19) United States
(12) Patent Application Publication
(10) Pub. No.: US 2025/0257790 A1
(43) Pub. Date: Aug. 14, 2025

(54) SPEED REDUCER

(71) Applicant: NIPPON THOMPSON CO., LTD., Tokyo (JP)

(72) Inventor: Satoshi SASAKI, Mino-shi (JP)

(73) Assignee: NIPPON THOMPSON CO., LTD., Tokyo (JP)

(21) Appl. No.: 18/856,977

(22) PCT Filed: Feb. 6, 2023
(86) PCT No.: PCT/JP2023/003747

§ 371 Date: Oct. 15, 2024

(30) Foreign Application Priority Data
Apr. 25, 2022 (JP) 2022-071624

(51) Int. Cl. F16H 1/32; F16C 35/063

(52) U.S. Cl. CPC F16H 1/32; F16C 35/063; F16C 2361/61; F16H 2001/325

(57) ABSTRACT

A speed reducer includes: an input unit including an input shaft and first bearing including eccentric first inner ring rotating together with the input shaft; cycloid gear; multiple inner pins, inner pin holder holding end portions of the inner pins in the axial directions and surrounding the input unit outer peripheral surface; second bearing radially outward of the cycloid gear and including a second inner ring as an output shaft, second outer ring radially outward of the second inner ring, and rolling body between the second inner and rings; and a plurality of outer pins held on a radially inner surface of the second inner ring and meshing with external teeth of the cycloid gear. The first inner ring is separate from the input shaft. The input unit includes a movement restrictor restricting movement of the first inner ring relative to the input shaft in the circumferential directions.

### TECHNICAL FIELD

The present disclosure relates to a speed reducer. This application claims priority to Japanese Patent Application No. 2022-071624, which was filed on Apr. 25, 2022, and is incorporated herein by reference in its entirety.

### BACKGROUND ART

Speed reducers have been used to date in control units for driving wheels in mobile devices, robots, and machine tools. Patent Literature 1, for example, describes a technique of this type.

A speed reducer described in Patent Literature 1 includes an input shaft including a pair of eccentric portions, a pair of cycloid gears to be in contact with the pair of eccentric portions, a hub serving as an output shaft, an output shaft pin holder, a plurality of outer pins, an outer pin holder holding the outer pins, and an inner pin supported by the hub. The hub is supported by the outer pin holder through a crossed roller bearing. The crossed roller bearing includes an outer ring fixed to the outer pin holder, an inner ring fixed to the hub, and a plurality of rollers between the outer ring and the inner ring.

### CITATION LIST

### Patent Literature

Patent Literature 1: Japanese Patent Application Laid-Open No. 2017-48852

### SUMMARY OF INVENTION

### Technical Problem

In speed reducers, improved productivity is required. Additionally, ensuring stable operation is also required. The technique disclosed in Patent Literature 1 is insufficient in terms of improvement of productivity and ensuring stable operation.

It is therefore an object to provide a speed reducer capable of ensuring stable operation with improved productivity.

### Solution to Problems

A speed reducer according to the present disclosure includes: an input unit including an input shaft and a first bearing, the first bearing including an eccentric first inner ring that rotates together with the input shaft; a cycloid gear located radially outward of the first bearing and including a plurality of external teeth arranged on an outer peripheral surface along circumferential directions, the cycloid gear including a first through hole the input unit penetrates and a plurality of second through holes located radially outward of the first through hole and arranged with intervals in the circumferential directions; a plurality of inner pins penetrating the second through holes in axial directions; an inner pin holder holding end portions of the plurality of inner pins in the axial directions and surrounding an outer peripheral surface of the input unit; a second bearing located radially outward of the cycloid gear, and including a second inner ring that is an output shaft, a second outer ring located radially outward of the second inner ring, and a rolling body located between the second inner ring and the second outer ring; and a plurality of outer pins held on a radially inner surface of the second inner ring and meshing with the external teeth of the cycloid gear. The first inner ring is provided separately from the input shaft. The input unit includes a movement restrictor that restricts movement of the first inner ring relative to the input shaft in the circumferential directions.

### Advantages of Invention

The speed reducer is capable of ensuring stable operation with improved productivity.

### BRIEF DESCRIPTION OF DRAWINGS

FIG. 1 is a schematic perspective view illustrating a speed reducer according to a first embodiment of the present disclosure.

FIG. 2 is a schematic front view of the speed reducer shown in FIG. 1.

FIG. 3 is a schematic side view of the speed reducer shown in FIG. 1.

FIG. 4 is a schematic rear view of the speed reducer shown in FIG. 1.

FIG. 5 is a schematic cross-sectional view taken along line V-V in FIG. 2.

FIG. 6 is an enlarged view of a portion of the cross section of the speed reducer shown in FIG. 5.

FIG. 7 is an enlarged view of a portion of the cross section of the speed reducer shown in FIG. 5.

FIG. 8 is a schematic cross-sectional view taken along line VIII-VIII in FIG. 5.

FIG. 9 is a schematic cross-sectional view taken along line IX-IX in FIG. 5.

FIG. 10 is a schematic perspective view illustrating a portion of an input unit included in the speed reducer.

FIG. 11 is a disassembled perspective view illustrating a portion of the input unit shown in FIG. 10.

FIG. 12 is a schematic perspective view in which a portion of the input unit shown in FIG. 10 is partially omitted and indicated by broken lines.

FIG. 13 is a schematic perspective view illustrating a portion of a first bearing included in the input unit.

FIG. 14 is a schematic cross-sectional view illustrating a portion of the input unit shown in FIG. 10.

FIG. 15 is a schematic cross-sectional view illustrating a portion of the input unit shown in FIG. 10.

FIG. 16 is a schematic perspective view in which a portion of inner pins is indicated by broken lines.

FIG. 17 is a schematic perspective view of an inner pin holder illustrating a state where inner pins are held by a combination of a first holder portion and a second holder portion.

FIG. 18 is a schematic perspective view of the first holder portion.

FIG. 19 is a schematic perspective view of the second holder portion.

FIG. 20 is a view of a cycloid gear as seen in an axial direction.

FIG. 21 is a schematic perspective view of a second outer ring.

FIG. 22 is an enlarged schematic cross-sectional view illustrating a portion of the speed reducer shown in FIG. 5.

FIG. 23 is an enlarged schematic cross-sectional view illustrating a portion of the second outer ring.

FIGS. 24 and 25 are schematic perspective views of the second inner ring.

FIGS. 24 and 25 are schematic perspective views of the second inner ring.

FIG. 26 is an enlarged schematic cross-sectional view illustrating a portion of the speed reducer including the second inner ring.

FIG. 27 is an enlarged schematic cross-sectional view illustrating a portion of the second inner ring and one outer pin.

FIG. 28 is a further enlarged schematic view illustrating the portion of the second inner ring and the outer pin shown in FIG. 27.

FIG. 29 is a schematic view illustrating an example of a cylindrical grinder used for grinding the second inner ring.

### DESCRIPTION OF EMBODIMENTS

### Summary of Embodiment

A speed reducer according to the present disclosure includes: an input unit including an input shaft and a first bearing, the first bearing including an eccentric first inner ring that rotates together with the input shaft; a cycloid gear located radially outward of the first bearing and including a plurality of external teeth arranged on an outer peripheral surface along circumferential directions, the cycloid gear including a first through hole the input unit penetrates and a plurality of second through holes located radially outward of the first through hole and arranged with intervals in the circumferential directions; a plurality of inner pins penetrating the second through holes in axial directions; an inner pin holder holding end portions of the plurality of inner pins in the axial directions and surrounding an outer peripheral surface of the input unit; a second bearing located radially outward of the cycloid gear, and including a second inner ring that is an output shaft, a second outer ring located radially outward of the second inner ring, and a rolling body located between the second inner ring and the second outer ring; and a plurality of outer pins held on a radially inner surface of the second inner ring and meshing with the external teeth of the cycloid gear. The first inner ring is provided separately from the input shaft. The input unit includes a movement restrictor that restricts movement of the first inner ring relative to the input shaft in the circumferential directions.

With this configuration, the input shaft and the first inner ring that are components of the input unit can be made of different materials. Then, a material suitable for the function required for each component can be selected to assemble the input unit. In this case, since the input unit includes the movement restrictor that restricts movement of the first inner ring relative to the input shaft in the circumferential directions, the first inner ring can be reliably positioned in the circumferential directions, and the first inner ring can be reliably rotated together with the input shaft. Accordingly, stable operation of the speed reducer can be ensured. In addition, since the components are made of separate members, accuracy in grinding of, for example, the eccentric first inner ring can be easily increased so that productivity can be thereby enhanced. Further, since the first inner ring is a separate member, a change of eccentricity of the first inner ring and sorting of accuracy, which would be difficult in an integrated input unit, can be easily performed. That is, the first inner rings fabricated in accordance with requirements can be selected and combined with the separately fabricated input shaft to produce the input unit that meets requirements. Since the input shaft is also a separate member, it becomes easier to perform additional machining on the input shaft or incorporate design changes according to an application. Specifically, a material such as a light metal exemplified by aluminum or a resin is employed as a material of the input shaft that is a component constituting the input unit in consideration of weight reduction and torque resistance, whereas bearing steel is employed as a material for the first inner ring in consideration of enhancement of durability. The speed reducer described above can ensure stable operation with enhanced productivity.

In the speed reducer, the movement restrictor may restrict movement of the first inner ring relative to the input shaft in the axial directions. Thus, the first inner ring in the axial directions is reliably positioned, thereby ensuring more stable operation of the speed reducer.

In the speed reducer, the movement restrictor includes the first keyway recessed from the outer peripheral surface of the input shaft, the second keyway recessed from the inner peripheral surface of the first inner ring, and the key member fitted in both the first keyway and the second keyway. Accordingly, by fitting the key member in the first keyway and the second keyway, the first inner ring can be reliably positioned in the circumferential directions.

In the speed reducer, the first keyway extends in the axial directions in a portion of the outer circumferential surface of the input shaft in the circumferential directions. The second keyway may be located at a position facing the first keyway. The key member may have a rod shape extending in the axial directions. Accordingly, the first inner ring can be more reliably positioned in the circumferential directions with a relatively simple structure.

In the speed reducer, at least an end portion of the first inner ring on one side in the axial directions may include a flange projecting radially outward. In this manner, in a case where needle rollers included in a needle cage constituted by the needle rollers and a retainer retaining the needle rollers roll on the outer peripheral surface of the first inner ring as a raceway surface, movement of the case included in the needle cage in the axial directions is restricted by using the flange. As a result, more stable operation of the speed reducer can be ensured.

In the speed reducer, the input unit may further include a guide ring that is provided separately from the input shaft and the first inner ring, has a disc shape, is located at least on one side of the first inner ring in the axial directions, and projects radially outward relative to a raceway surface of the first inner ring. With this configuration, movement of the retainer included in the needle cage in the axial directions can also be restricted by the guide ring. As a result, more stable operation of the speed reducer can be ensured. Similarly, a material for the guide ring included in the input unit can be selected independently of materials for other components, and may be a resin such as PEEK containing fibers or a light metal such as aluminum, for example.

In the speed reducer, the first bearing may include a pair of first bearings arranged in the axial directions. The first inner ring may include a pair of first inner rings included in the pair of first bearings, and the pair of first inner rings may be arranged with a 180-degree phase shift in the circumferential directions. With this configuration, influence of the eccentric first inner ring during rotation of the input shaft is reduced so that more stable rotation of the input shaft can be thereby ensured.

In the speed reducer, the first inner ring may be fixed to the input shaft by interference fitting. This configuration can also restrict movement of the first inner ring relative to the input in the axial directions.

### SPECIFIC EXAMPLES OF EMBODIMENT

Next, examples of specific embodiments of a speed reducer according to the present disclosure will be described with reference to the drawings. In the following drawings, the same or corresponding parts are denoted by the same reference numerals, and the description thereof will not be repeated.

### First Embodiment

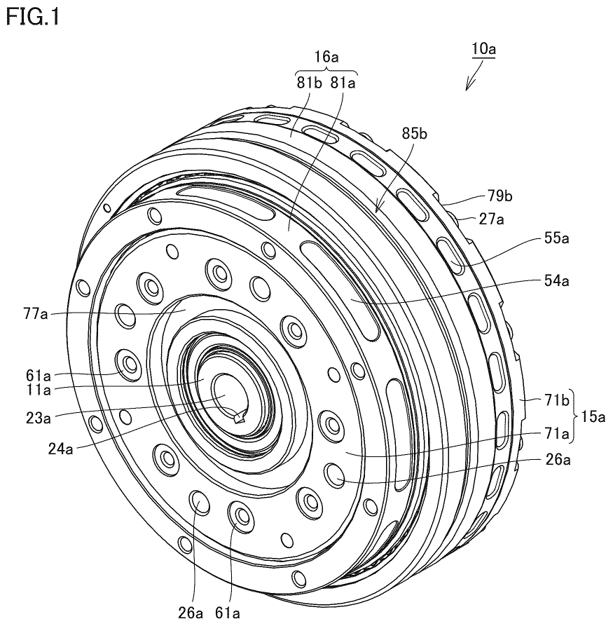

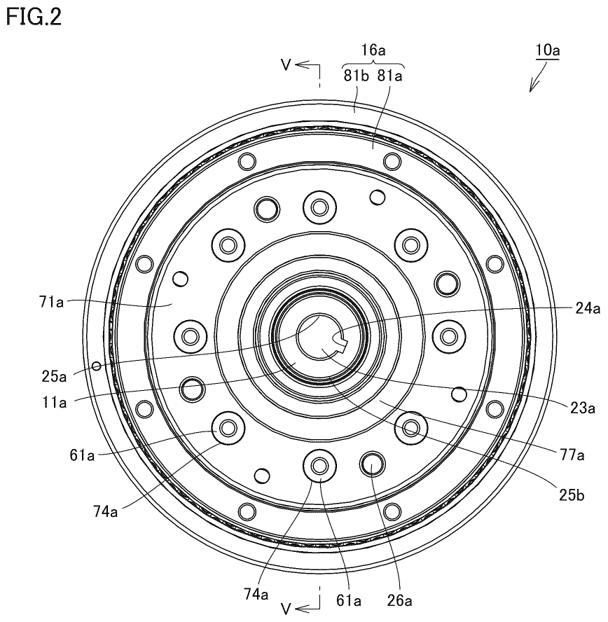

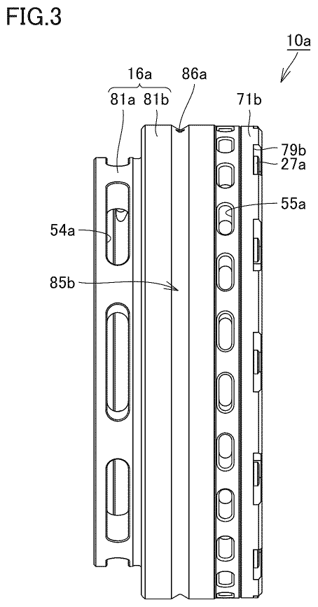

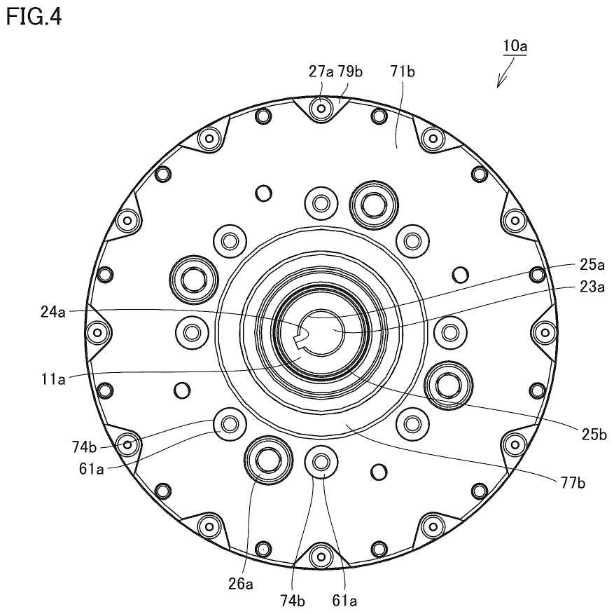

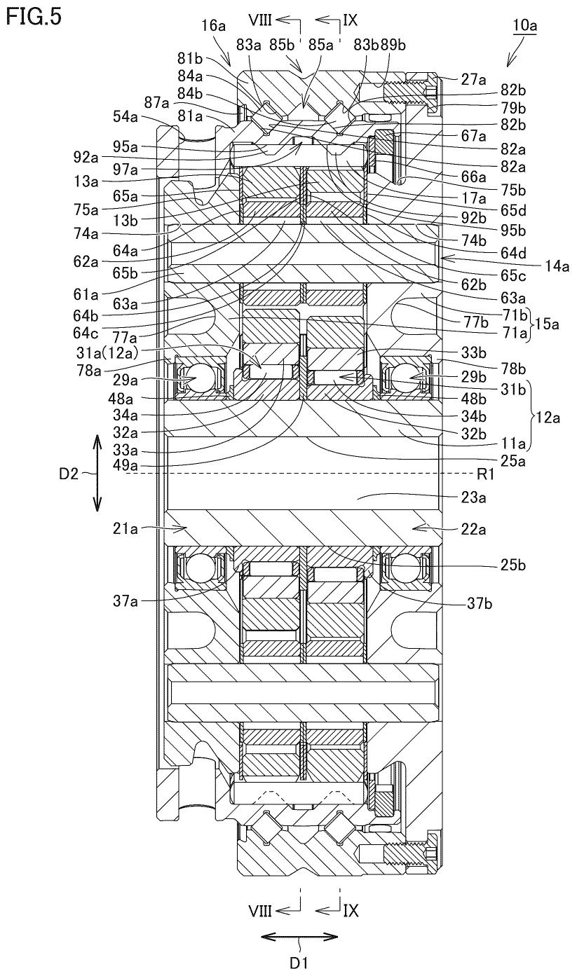

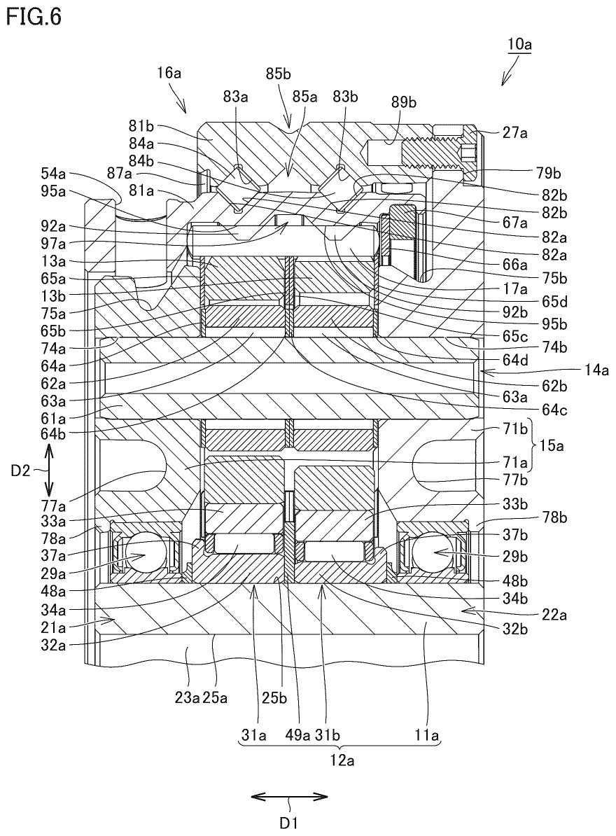

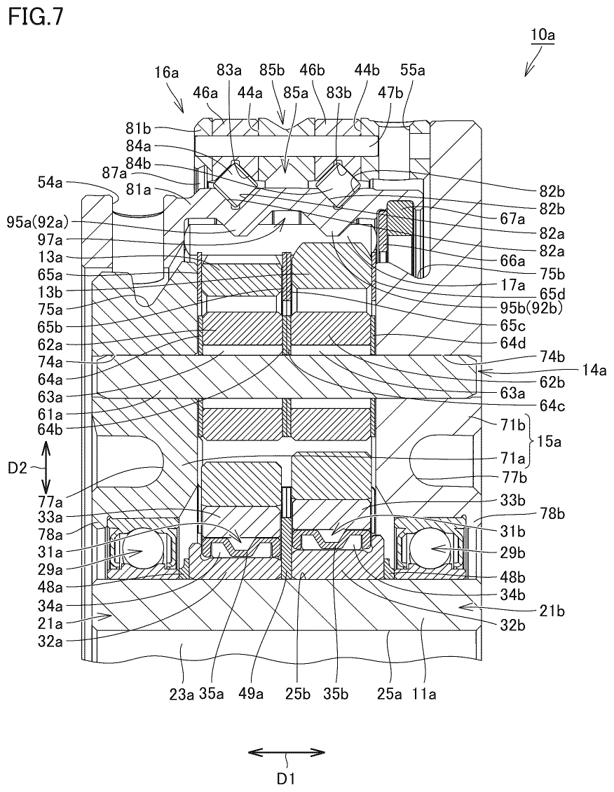

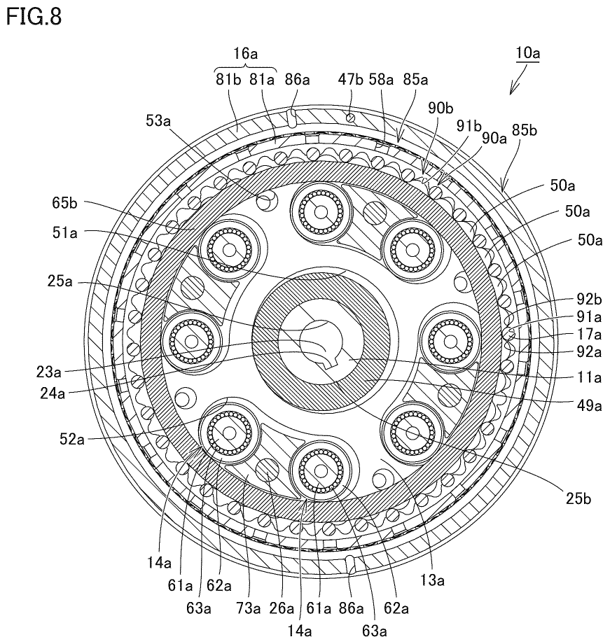

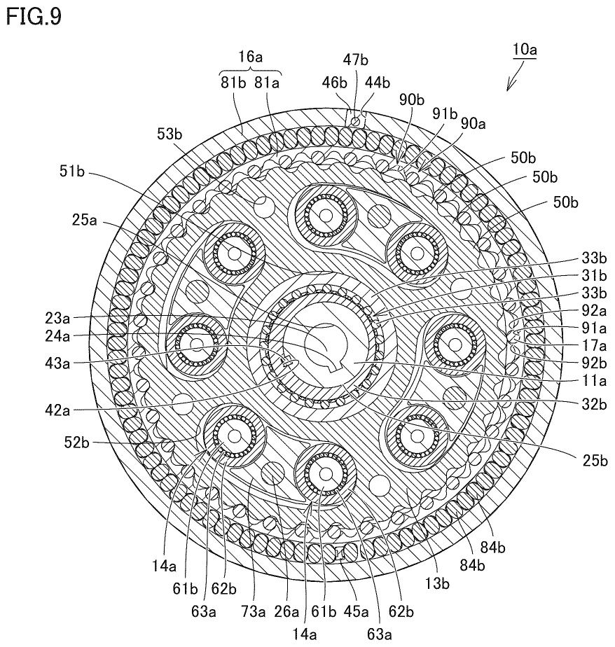

First, a first embodiment, which is an embodiment of the present disclosure, will be described. FIG. 1 is a schematic perspective view illustrating a speed reducer according to the first embodiment of the present disclosure. FIG. 2 is a schematic front view of the speed reducer shown in FIG. 1. FIG. 3 is a schematic side view of the speed reducer shown in FIG. 1. FIG. 4 is a schematic rear view of the speed reducer shown in FIG. 1. FIG. 5 is a schematic cross-sectional view taken along line V-V in FIG. 2. FIGS. 6 and 7 are enlarged views illustrating a portion of the cross section of the speed reducer shown in FIG. 5. FIG. 6 is a cross-sectional view taken in a plane along circumferential directions excluding a lid described later. FIG. 7 is a cross-sectional view taken in a plane along the circumferential directions including the lid described later. FIG. 8 is a schematic cross-sectional view taken along line VIII-VIII in FIG. 5. FIG. 9 is a schematic cross-sectional view taken along line IX-IX in FIG. 5. In FIG. 5, for example, arrow D1 represents axial directions and arrow D2 represents radial directions. Broken line R1 represents a rotation center axis of a speed reducer 10a.

With reference to FIGS. 1 through 9, the speed reducer 10a according to the first embodiment of the present disclosure reduces a rotation speed of an input shaft 11a that is rotating at high speed, and outputs the reduced rotation speed from an output shaft described later. In this embodiment, the deceleration rate is 1/36. That is, when the rotation speed of the input shaft is 3000 revolutions per minute (rpm), the rotation speed of the output shaft is about 83.3 rpm. The deceleration rate is, of course, set at any value as required depending on the number of teeth of cycloid gears, the number of outer pins, the degree of eccentricity of a first inner ring, and so forth.

The speed reducer 10a includes: an input unit 12a including an input shaft 11a and first bearings 31a and 31b respectively including eccentric first inner rings 32a and 32b that rotate together with the input shaft 11a; cycloid gears 13a and 13b; a plurality of inner pins 14a; an inner pin holder 15a; a second bearing 16a including a second inner ring 81a and a second outer ring 81b; and a plurality of outer pins 17a. The first bearings 31a and 31b are disposed as a pair in the axial directions, and the cycloid gears 13a and 13b are disposed as a pair in the axial directions. The components will be described below.

The input shaft 11a has a hollow cylindrical shape. Specifically, the input shaft 11a has an axial through hole 23a penetrating the input shaft 11a in the axial directions from a first axial end 21a that is one end in the axial directions to a second axial end 21b that is the other end in the axial directions. An inner peripheral surface 25a of the input shaft 11a constituting the axial through hole 23a has an axial inner peripheral surface keyway 24a. In the axial inner peripheral surface keyway 24a, a portion of the inner peripheral surface 25a in the circumferential directions is recessed radially outward. The use of this axial inner peripheral surface keyway 24a reduces a slip of the input shaft 11a relative to the rotation axis in the rotation directions when a rotation shaft (not shown) of a motor is coupled to the input shaft 11a. An outer peripheral surface 25b of the input shaft 11a extends straight in the axial directions. The inner peripheral surface 25a of the input shaft 11a extends straight in the axial directions except for a region where the axial inner peripheral surface keyway 24a is present. This input shaft 11a has a relatively simple structure, and thus, costs can be reduced. The input shaft 11a may have a solid cylindrical shape when necessary.

The input shaft 11a may be made of, for example, a metal. In this embodiment, aluminum is employed as a material for the input shaft 11a. The material for the input shaft 11a only needs to be a material that can receive a torque of the motor, and may be a resin, for example.

A first input shaft bearing 29a and a second input shaft bearing 29b that are two bearings supporting the input shaft 11a are attached to the input shaft 11a. The first input shaft bearing 29a is attached to the first axial end 21a, and the second input shaft bearing 29b is attached to the second axial end 21b. The first input shaft bearing 29a and the second input shaft bearing 29b are spaced in the axial directions. An inner ring of the first input shaft bearing 29a and an inner ring of the second input shaft bearing 29b are both fixed to the input shaft 11a. An outer ring of the first input shaft bearing 29a and an outer ring of the second input shaft bearing 29b are both fixed to an inner pin holder 15a described later and serving as a fixing portion. The first input shaft bearing 29a and the second input shaft bearing 29b are, for example, deep groove ball bearings. The input shaft 11a is rotatably supported by these first input shaft bearing 29a and second input shaft bearing 29b. The first input shaft bearing 29a is in contact with a step 78a of a first holder portion 71a included in the inner pin holder 15a described later in the axial directions to thereby restrict movement in the axial directions. The second input shaft bearing 29b is in contact with a step 78b of a second holder portion 71b included in the inner pin holder 15a described later to thereby restrict movement in the axial directions.

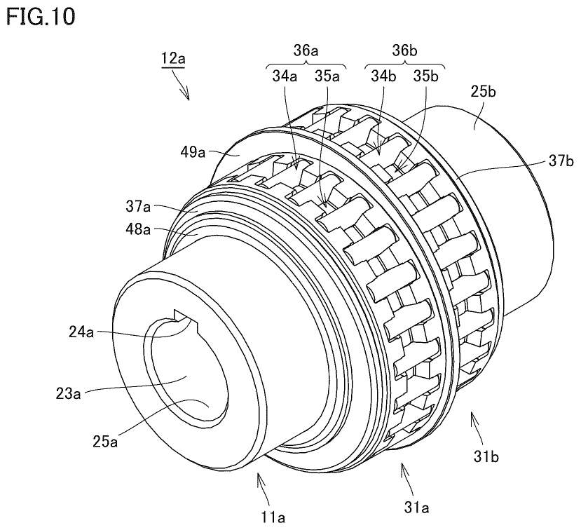

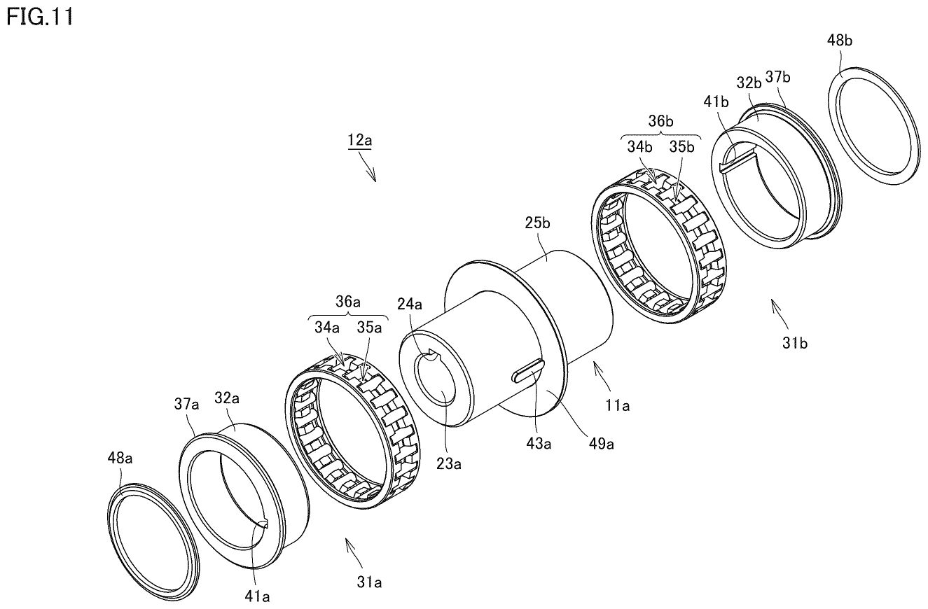

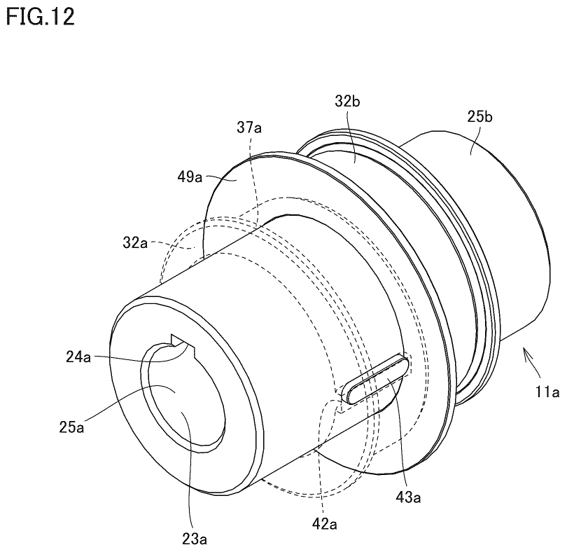

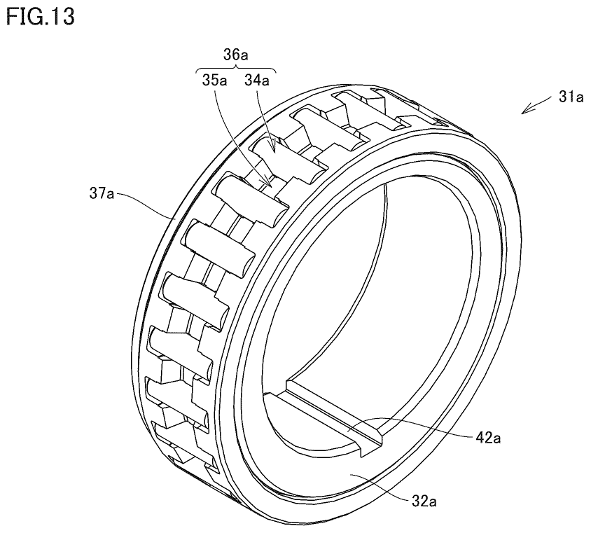

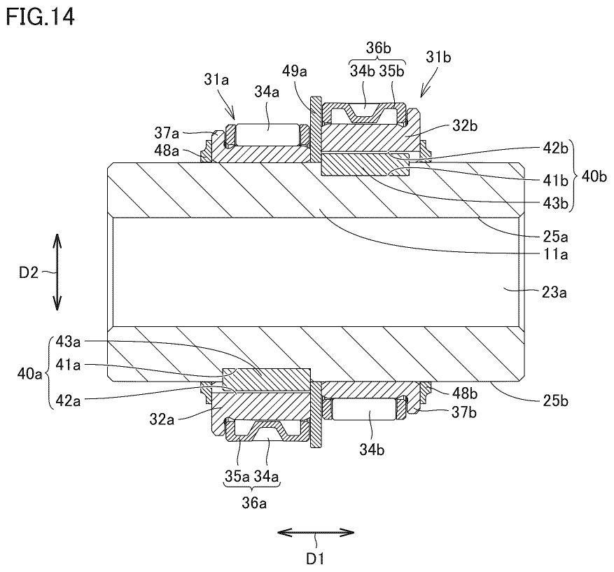

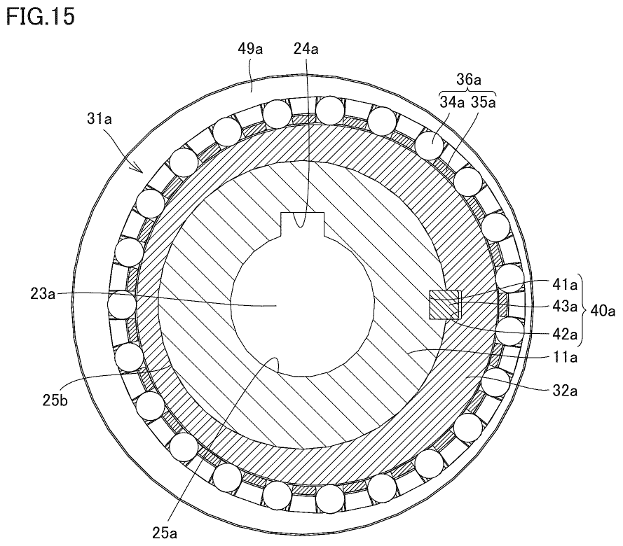

Next, a detailed configuration of the input unit 12a will be described. FIG. 10 is a schematic perspective view illustrating a portion of the input unit 12a included in the speed reducer 10a. FIG. 11 is a disassembled perspective view illustrating a portion of the input unit 12a shown in FIG. 10. FIG. 12 is a schematic perspective view in which a portion of the input unit 12a shown in FIG. 10 is omitted and indicated by broken lines. FIG. 13 is a schematic perspective view illustrating a portion of the first bearing 31a included in the input unit 12a. FIG. 14 is a schematic cross-sectional view illustrating a portion of the input unit 12a shown in FIG. 10. FIG. 14 is a cross-sectional view taken in a plane including a rotation center axis of the first bearing 31a. FIG. 15 is a schematic cross-sectional view illustrating a portion of the input unit 12a shown in FIG. 10. FIG. 15 is a cross-sectional view taken in a plane including the first bearing 31a and perpendicular to the axial directions.

With reference to FIGS. 10 through 15, the input unit 12a includes the input shaft 11a, the first bearing 31a, and the first bearing 31b, as described above. The first bearing 31a includes the eccentric first inner ring 32a that rotates together with the input shaft 11a, the first outer ring 33a located radially outward of the first inner ring 32a, and a needle cage 36a. The needle cage 36a is constituted by needle rollers 34a as a plurality of rolling bodies located between the first inner ring 32a and the first outer ring 33a in the radial directions, and a retainer 35a retaining the needle rollers 34a. The needle rollers 34a included in the needle cage 36a constituted by the needle rollers 34a and the retainer 35a retaining the needle rollers 34a roll on the outer peripheral surface of the first inner ring 32a as a raceway surface. The first bearing 31b includes the eccentric first inner ring 32b that rotates together with the input shaft 11a, the first outer ring 33b located radially outward of the first inner ring 32b, and a needle cage 36b. The needle cage 36b is constituted by needle rollers 34b as a plurality of rolling bodies located between the first inner ring 32b and the first outer ring 33b in the radial directions, and a retainer 35b retaining the needle rollers 34b. The needle rollers 34b included in the needle cage 36b constituted by the needle rollers 34b and the retainer 35b retaining the needle rollers 34b roll on the outer peripheral surface of the first inner ring 32b as a raceway surface. The first inner rings 32a and 32b are fixed to the input shaft 11a by interference fit. The first bearings 31a and 31b are located between the first input shaft bearing 29a and the second input shaft bearing 29b in the axial directions. The first input shaft bearing 29a and the first bearing 31a are adjacent to each other in the axial directions, and the second input shaft bearing 29b and the first bearing 31b are adjacent to each other in the axial directions.

In the speed reducer 10a of the present disclosure, the first inner ring 32a included in the first bearing 31a and the first inner ring 32b included in the first bearing 31b are each provided separately from the input shaft 11a. The input unit 12a includes movement restrictors 40a and 40b that restrict movement of the first inner rings 32a and 32b relative to the input shaft 11a. The movement restrictors 40a and 40b included in the input unit 12a include first keyways 41a and 41b, second keyways 42a and 42b, and key members 43a and 43b. Each of the first keyways 41a and 41b is recessed from the outer peripheral surface 25b of the input shaft 11a. In this embodiment, each of the first keyways 41a and 41b extends in the axial directions in a portion of the outer peripheral surface 25b of the input shaft 11a in the circumferential directions. The first keyways 41a and 41b are located at different positions in the axial directions and the circumferential directions. Specifically, in the axial directions, the first keyway 41a is located between the position at which a guide ring 49a is placed and the first axial end 21a, and the first keyway 41b is located between the position at which the guide ring 49a is placed and the second axial end 21b. In the circumferential directions, the first keyway 41a is located at a position that is rotated 180 degrees from the first keyway 41b. Each of the first keyways 41a and 41b is located at a position that is rotated 90 degrees from the position at which the axial inner peripheral surface keyway 24a is located in the circumferential directions.

The second keyways 42a and 42b is recessed from the inner peripheral surfaces of the first inner rings 32a and 32b, respectively. In this embodiment, the second keyways 42a and 42b penetrate portions of the first inner rings 32a and 32b, respectively, in the circumferential directions to form groove shapes in the axial directions. The second keyways 42a and 42b are located in regions of the first inner rings 32a and 32b each having largest eccentricity in the circumferential directions. The second keyways 42a and 42b are located at positions corresponding to the first keyways 41a and 41b when the first inner rings 32a and 32b are attached to the input shaft 11a such that the inner peripheral surfaces of the first inner rings 32a and 32b face the outer peripheral surface of the input shaft 11a.

Each of the key members 43a and 43b has a rod shape with a rectangular cross section. The key members 43a and 43b are fitted in spaces defined by the first keyways 41a and 41b and the second keyways 42a and 42b when the second keyways 42a and 42b are located to face the respective first keyways 41a and 41b. That is, the key members 43a and 43b are shaped to be fitted in the first keyways 41a and 41b and the second keyways 42a and 42b, respectively. Corners of end portions of the key members 43a and 43b are rounded.

Axial end portions of the first inner rings 32a and 32b include flanges 37a and 37b extending radially outward. The input unit 12a has a disc shape, and includes the guide ring 49a located on one side of the first inner rings 32a and 32b in the axial directions and projecting radially outward relative to the raceway surface of the first inner ring 32a. The guide ring 49a is located on the other side of the first inner rings 32a and 32b in the axial directions. That is, the first bearing 31a and the first bearing 31b sandwich the guide ring 49a in the axial directions. The flange 37a is located at one end of the raceway surface of the first inner ring 32a in the axial directions, and the guide ring 49a is located at the other end of the raceway surface of the first inner ring 32a in the axial directions. A ring-shaped collar 48a for adjusting a gap in the axial directions formed in attaching the first inner ring 32a is located on one side of the first inner ring 32a in the axial directions. The flange 37b is located at one end of the raceway surface of the first inner ring 32b in the axial directions, and the guide ring 49a is located at the other end of the raceway surface of the first inner ring 32b in the axial directions. A ring-shaped collar 48b for adjusting a gap in the axial directions formed in attaching the first inner ring 32b is located on one side of the first inner ring 32b in the axial directions. The guide ring 49a is made of a metal in this embodiment, and may be subjected to heat treatment and grinding finish. Specifically, the guide ring 49a is made of duralumin, and may be anodized or subjected to other treatments.

Next, assembly of the input unit 12a will be described briefly. First, the input shaft 11a is prepared. Then, the guide ring 49a is fitted onto the input shaft 11a from one side in the axial directions, and then, the key members 43a and 43b are fitted in the first keyways 41a and 41b, respectively. The guide ring 49a is sandwiched between axial ends of the two opposed key members 43a and 43b to be fixed in the axial directions. In this manner, the guide ring 49a is positioned in the axial directions. Then, the first inner ring 32a to which the needle cage 36a is attached on the radially outer side from the side where the flange 37a is not located, is fitted onto the input shaft 11a from one side in the axial directions. At this time, the first inner ring 32a is fitted such that the circumferential position of the second keyway 42a coincides with the position of the key member 43a. Then, the first inner ring 32a is pushed along the axial directions such that the end surface of the first inner ring 32a where the flange 37a is not located contacts the guide ring 49a. In this manner, the first inner ring 32a is fitted onto the input shaft 11a. The retainer 35a of the needle cage 36a is sandwiched between the guide ring 49a and the flange 37a of the first inner ring 32a to be restricted in the axial directions. Further, the first inner ring 32b to which the needle cage 36b is attached on the radially outer side from the side where the flange 37b is not located, is fitted onto the input shaft 11a from the other side in the axial directions. Then, the first inner ring 32b is pushed along the axial directions such that the end surface of the first inner ring 32b where the flange 37b is not located contacts the guide ring 49a. At this time, in a manner similar to the case of the first inner ring 32a, the first inner ring 32b is also fitted such that the circumferential position of the second keyway 42b coincides with the position of the key member 43b. The retainer 35b of the needle cage 36b is sandwiched between the guide ring 49b and the flange 37b of the first inner ring 32b to be restricted in the axial directions. In this manner, the first inner rings 32a and 32b are fitted onto the input shaft 11a. The fitting of the first inner rings 32a and 32b onto the input shaft 11a is interference fitting. Specifically, for example, the first inner rings 32a and 32b are press fitted onto the input shaft 11a, and are also assembled by shrink fitting. Thereafter, the collars 48a and 48b are fitted onto the input shaft 11a in the axial directions. In this manner, the input unit 12a is assembled.

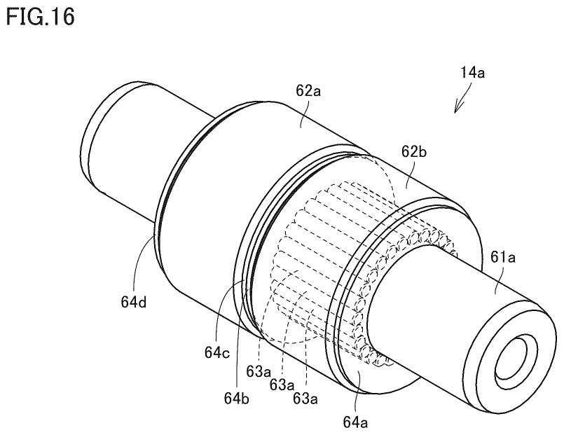

A configuration of the inner pins 14a will now be described. FIG. 16 is a schematic perspective view in which a portion of the inner pins 14a is indicated by broken lines. With reference to FIG. 16, the inner pin 14a includes a hollow cylindrical shank 61a, two annular inner pin outer rings 62a and 62b each having an inner diameter larger than the outer diameter of the shank 61a, rollers 63a as a plurality of rolling bodies disposed between the outer peripheral surface of the shank 61a and the inner peripheral surfaces of the inner pin outer rings 62a and 62b, and a plurality of thrust washers 64a, 64b, 64c, and 64d arranged in the thrust directions. That is, the inner pin 14a is constituted as a rolling bearing using the plurality of rollers 63a as rolling bodies. The inner pin outer rings 62a and 62b are arranged in the axial directions while sandwiching the thrust washers 64b and 64c therebetween. Each of the thrust washers 64a, 64b, 64c, and 64d is made of a thermoplastic resin such as a polyetheretherketone (PEEK), but is not limited to this example. The inner pin 14a does not include a so-called retainer, and is of a full component roller type. The inner pin 14a may be a plain bearing. The inner pin 14a functions as a so-called planet shaft. In this embodiment, a total of eight inner pins 14a are provided.

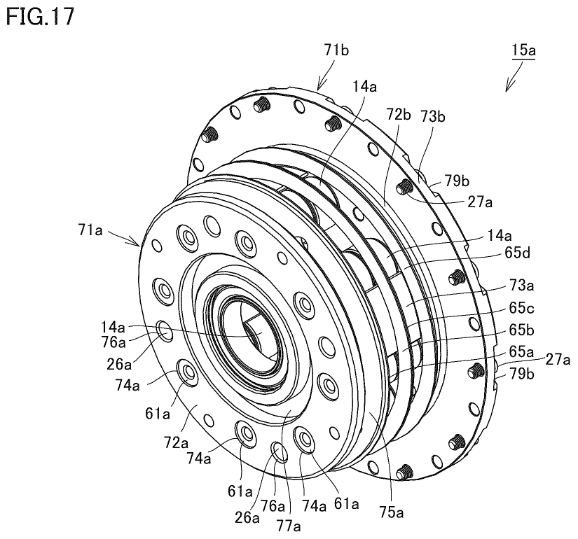

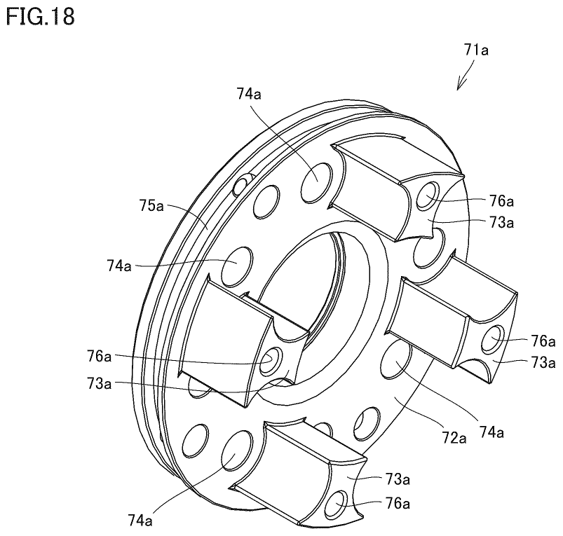

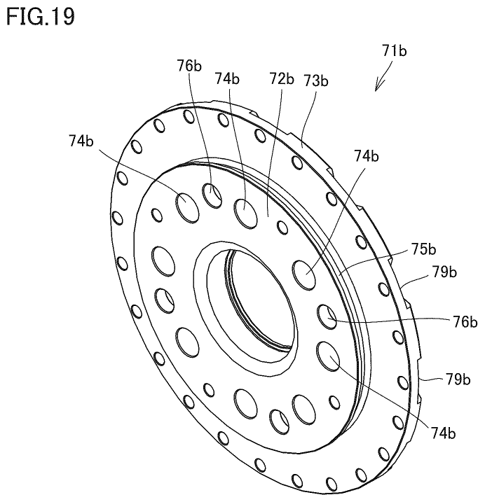

Next, a configuration of the inner pin holder 15a will be described. The inner pin holder 15a includes the first holder portion 71a and the second holder portion 71b. The inner pin holder 15a supports the inner pins 14a, specifically, both ends of the shanks 61a included in the inner pins 14a. The inner pin holder 15a functions as a planet shaft supporter that supports planet shafts in a case where the shanks 61a of the inner pins 14a are the planet shafts. FIG. 17 is a schematic perspective view of the inner pin holder 15a illustrating a state where the inner pins 14a are held by a combination of the first holder portion 71a and the second holder portion 71b. FIG. 18 is a schematic perspective view of the first holder portion 71a. FIG. 19 is a schematic perspective view of the second holder portion 71b. FIG. 17 also shows the thrust washers 65a, 65b, 65c, and 65d.

With reference to FIGS. 17, 18, and 19, the first holder portion 71a includes a disc-shaped plate portion 72a in which a through hole penetrating the plate portion 72a in the thickness directions is located at the center in the radial directions, and a plurality of support columns 73a projecting along the thickness directions from one surface of the plate portion 72a on one side in the thickness directions. The plate portion 72a and the plurality of support columns 73a are integrated. In this embodiment, four support columns 73a are provided at 90-degree intervals. The plate portion 72a has a plurality of press-fitting holes 74a in which end portions of the shanks 61a of the inner pins 14a on one side can be press fitted, with intervals in the circumferential directions. The press-fitting holes 74a penetrate the plate portion 72a in the thickness directions, and a total of eight press-fitting holes 74a are provided, corresponding to the number of the inner pins 14a. From the viewpoint of weight reduction, the outer peripheral surface of the plate portion 72a has an annular recessed groove 75a that is recessed radially inward.

The support columns 73a connect the plate portion 72a of the first holder portion 71a to the second holder portion 71b. A total of four support columns 73a are provided. The support columns 73a are located within second through holes 52a and 52b of the cycloid gears 13a and 13b described later when assembled into the speed reducer 10a. End surfaces of the support columns 73a in the circumferential directions are recessed in arc shapes in the circumferential directions as seen in the axial direction along the outer shapes of the inner pin outer rings 62a and 62b included in the inner pins 14a. The end surfaces of the support columns 73a in the radial directions have arc shapes as seen in the axial direction. The support columns 73a have screw holes 76a that are recessed along the thickness directions of the plate portion 72a and used for attaching the first holder portion 71a to the second holder portion 71b. In this embodiment, four screw holes 76a are provided at 90-degree intervals in the circumferential directions. From the viewpoint of weight reduction, in the thickness directions of the plate portion 72a, the surface opposite to the surface from which the support columns 73a project has an annular recessed groove 77a recessed in the thickness directions, on the radially outer side of the through hole at the center in the radial directions.

The second holder portion 71b has a disc shape having a through hole penetrating the second holder portion 71b in the thickness directions at the center in the radial directions. The second holder portion 71b includes a first portion 72b located at a center side in the radial directions, and a second portion 73b located radially outward of the first portion 72b and thinner than the first portion 72b. The first portion 72b has a plurality of press-fitting holes 74b in which end portions of the shanks 61a of the inner pins 14a on the other side can be press fitted, with intervals in the circumferential directions. The press-fitting holes 74b penetrate the second holder portion 71b in the thickness directions, and a total of eight press-fitting holes 74b are provided, corresponding to the number of the inner pins 14a. From the viewpoint of weight reduction, the outer peripheral surface of the first portion 72b has an annular recessed groove 75b that is recessed radially inward. The first portion 72b has a plurality of through holes 76b penetrating the first portion 72b along the thickness directions of the first portion 72b and used for attaching the first holder portion 71a to the second holder portion 71b, with intervals in the circumferential directions. In this embodiment, four through holes 76b are provided at 90-degree intervals, in accordance with the number and arrangement of the screw holes 76a. The second portion 73b of the second holder portion 71b has notches 79b that are arranged along the outer peripheral surface with intervals in the circumferential directions to reduce the thickness. Through holes penetrating the second holder portion 71b in the axial directions are provided in regions where the notches 79b are provided. The notches 79b and the through holes are located at positions corresponding to bolt holes 89b of the second outer ring 81b described later, and the second outer ring 81b is fixed to the second holder portion 71b with bolts 27a.

An example of a method for assembling the inner pin holder 15a will be described briefly as follows. First, end portions of the shanks 61a of the eight inner pins 14a on one side are press fitted in the eight press-fitting holes 74a of the first holder portion 71a. End portions of the shanks 61a of the inner pins 14a on the other side are press fitted in the eight press-fitting holes 74b of the second holder portion 71b. Thereafter, with four bolts 26a prepared beforehand, the bodies of the bolts 26a are inserted through the four through holes 76b and fastened by using the four screw holes 76a, thereby assembling the inner pin holder 15a. The support columns 73a located between the two inner pins 14a and the two inner pins 14a in the circumferential directions are located within the second through holes 52a of the cycloid gears 13a and 13b described later.

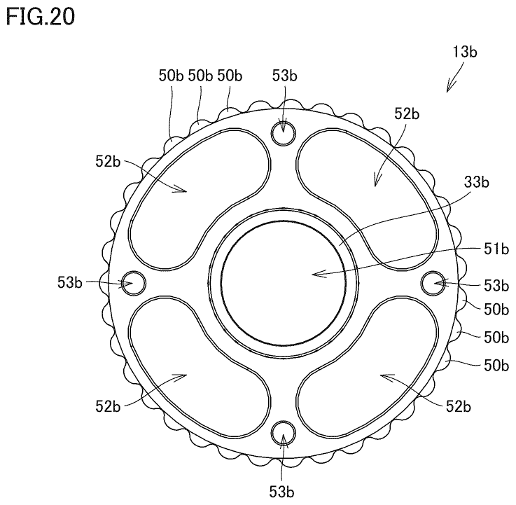

Next, a configuration of the cycloid gear 13b will be described. FIG. 20 is a view of the cycloid gear 13b as seen in an axial direction. With reference to FIG. 20, the cycloid gear 13b is located radially outward of the first bearing 31a. The cycloid gear 13b includes a plurality of external teeth 50b arranged on the outer peripheral surface along the circumferential directions. In this embodiment, the external teeth 50b have an epitrochoid parallel curve. The number of the external teeth 50b is 35 in this embodiment. The cycloid gear 13b have a circular first through hole 51b the input unit 12a penetrates, and a plurality of second through holes 52b located radially outward of the first through hole 51b and arranged with intervals in the circumferential directions. From the viewpoint of weight reduction of the speed reducer 10a, the cycloid gear 13b has a plurality of circular third through holes 53b located further radially outward of the first through hole 51b and each located between the plurality of second through holes 52b arranged with intervals in the circumferential directions. Each of the plurality of third through holes 53b is located between adjacent ones of the second through holes 52b in the circumferential directions. In this embodiment, four second through holes 52b and four third through holes 53b are provided. The first outer ring 33b of the first bearing 31b is fitted in the first through hole 51b of the cycloid gear 13b. The second through holes 52b are elongated holes extending along the circumferential directions, and wall surfaces positioned in the radial directions have arc-shaped portions. A gap in the circumferential directions is defined between each of the second through holes 52b and two inner pins 14a in this second through hole 52b. A gap is also defined between the cycloid gear 13b and outer pins 17a described later.

In a manner similar to the cycloid gear 13b, the cycloid gear 13a includes a plurality of external teeth 50a arranged on the outer peripheral surface along the circumferential directions. In a manner similar to the cycloid gear 13b, the cycloid gear 13a includes a first through hole 51a, a plurality of second through holes 52a, and a plurality of third through holes 53a. A configuration of the cycloid gear 13a is similar to that of the cycloid gears 13b, and thus, will not be described in detail.

Then, a configuration of the outer pins 17a will be described briefly. The outer pins 17a have solid cylindrical shapes. Ends of the outer pins 17a in the axial directions are chamfered. The outer pins 17a are oriented in the speed reducer 10a such that the axial directions coincide with the directions indicated by arrow D1. In this embodiment, the number of the outer pins 17a is 36. That is, the number of the outer pins 17a is larger, by one, than the number of the external teeth 50a and 50b of the cycloid gears 13a and 13b described above. To restrict movement of the outer pins 17a in the axial directions, an annular outer pin guide plate 66a and a retaining ring 67a are provided on one side of the outer pins 17a in the axial directions. The retaining ring 67a is formed by partially cutting out an annular member and is shrunk radially inward, and can be placed radially inside the second inner ring 81a. After the placement, the retaining ring 67a returns to the original shape by elastic deformation.

Next, a configuration of the second bearing 16a as a main bearing will be described. In this embodiment, the second bearing 16a as the main bearing of the speed reducer 10a includes the second inner ring 81a having raceway surfaces 82a and 82b, the second outer ring 81b having raceway surfaces 83a and 83b, and a plurality of cylindrical rollers 84a and 84b. In the speed reducer 10a according to the first embodiment of the present disclosure, the second inner ring 81a of the second bearing 16a serves as an output shaft that reduces the rotation speed of the input shaft 11a and outputs the reduced rotation speed. The second bearing 16a is a crossed roller bearing. That is, the cylindrical rollers 84a and 84b included in the main bearing alternately crossed at right angles to each other in a space between the second inner ring 81a and the second outer ring 81b in the radial directions. Specifically, the rolling axes of the two cylindrical rollers 84a and 84b adjacent to each other in the circumferential directions are orthogonal to each other. In this embodiment, the second bearing 16a is a multi-row crossed roller bearing. Specifically, a row of the cylindrical rollers 84a and a row of the cylindrical rollers 84b are located adjacent to each other in the axial directions. The second bearing 16a is of a full component roller type. That is, the second bearing 16a does not include a retainer for retaining the plurality of cylindrical rollers 84a and 84b.

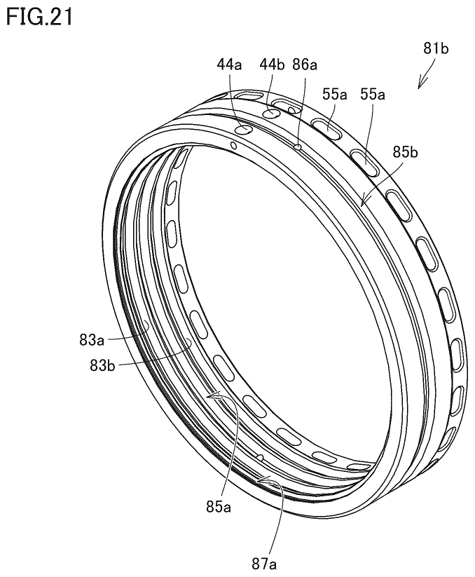

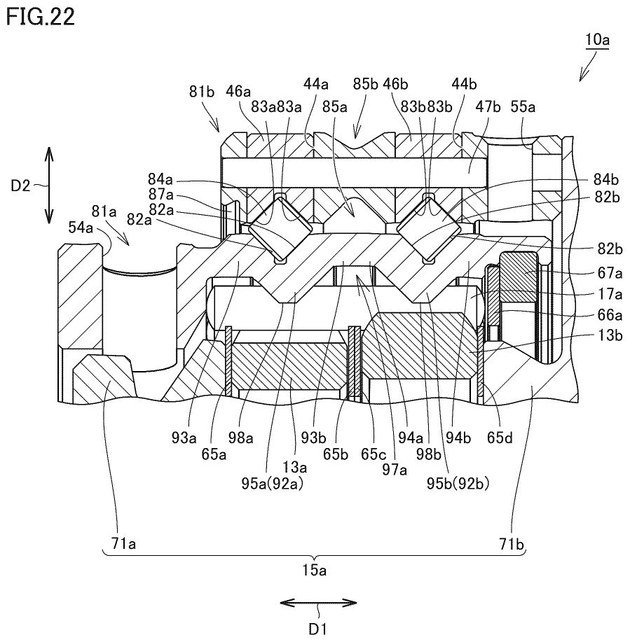

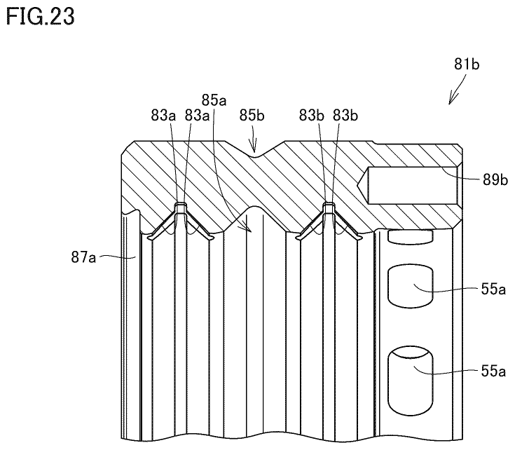

Then, a specific configuration of the second inner ring 81a and the second outer ring 81b that are components of the second bearing 16a will be described. First, a configuration of the second outer ring 81b will be described. FIG. 21 is a schematic perspective view of the second outer ring 81b. FIG. 22 is an enlarged schematic cross-sectional view illustrating a portion of the speed reducer 10a shown in FIG. 5. FIG. 23 is an enlarged schematic cross-sectional view illustrating a portion of the second outer ring 81b. With reference to FIGS. 21, 22, and 23, the second outer ring 81b has an annular shape, and the inner peripheral surface of the second outer ring 81b includes the raceway surfaces 83a and 83b each provided in a plurality of rows on which the cylindrical rollers 84a and 84b roll. The raceway surfaces 83a and 83b are adjacent to each other in the axial directions. The raceway surfaces 83a and 83b are provided as a pair and arranged in the axial directions. Each of the raceway surfaces 83a and 83b is recessed radially outward in a V shape in cross section. The pair of raceway surfaces 83a and 83b tilts at 45 degrees relative to the axial directions. An annular oil groove 85a that is recessed radially outward in a V shape in cross section is provided between the raceway surfaces 83a and 83b in the axial directions. An annular oil groove 85a that is recessed radially inward in a V shape in cross section is also provided on the outer peripheral surface of the second outer ring 81b. In the axial directions, the position of the oil groove 85a and the position of the oil groove 85b are the same. An oil hole 86a penetrating the second outer ring 81b in the axial directions is provided to connect the oil groove 85a and the oil groove 85b. An opening portion of the second outer ring 81b on the side opposite to the bolt holes 89b described later in the axial direction has an annular groove 87a that is recessed radially outward. The annular groove 87a is used for attaching a seal for enhancing hermeticity. In this embodiment, no seals are used and shown in the drawings.

The second outer ring 81b has insertion holes 44a and 44b penetrating the second outer ring 81b from the outer peripheral surface to a region where the cylindrical rollers 84a and 84b are located, and the cylindrical rollers 84a and 84b are inserted in the insertion holes 44a and 44b. The plurality of cylindrical rollers 84a and 84b are sequentially inserted in the insertion holes 44a and 44b. After all the cylindrical rollers 84a and 84b have been inserted, a spacer 45a for adjusting a gap between the cylindrical rollers 84a and 84b in the circumferential directions is inserted. After all the members have been inserted, the insertion holes 44a and 44b are closed by lids 46a and 46b. The lids 46a and 46b are fixed by lid fixing pins 47b penetrating the lids 46a and 46b and portions of the second outer ring 81b in the axial directions. From the viewpoint of weight reduction, the second outer ring 81b has elongated holes 55a each having the longitudinal directions in the circumferential directions, penetrating the second outer ring 81b in the radial directions, and arranged at regular intervals in the circumferential directions. The second outer ring 81b has a plurality of bolt holes 89b arranged with intervals in the circumferential directions. The bolt holes 89b are used for attaching the second outer ring 81b to the inner pin holder 15a, specifically, the second holder portion 71b, with the bolts 27a. That is, the second outer ring 81b is also a fixing portion and neither rotates nor revolves, in a manner similar to the inner pin holder 15a.

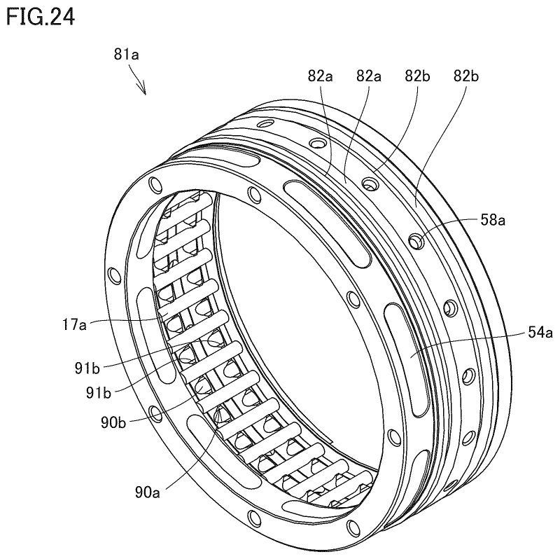

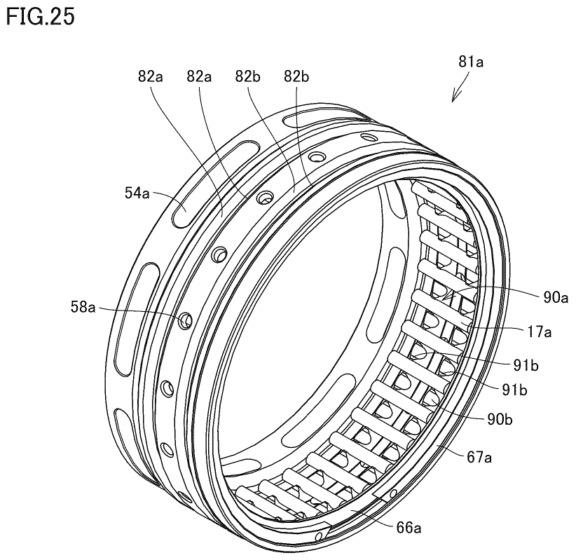

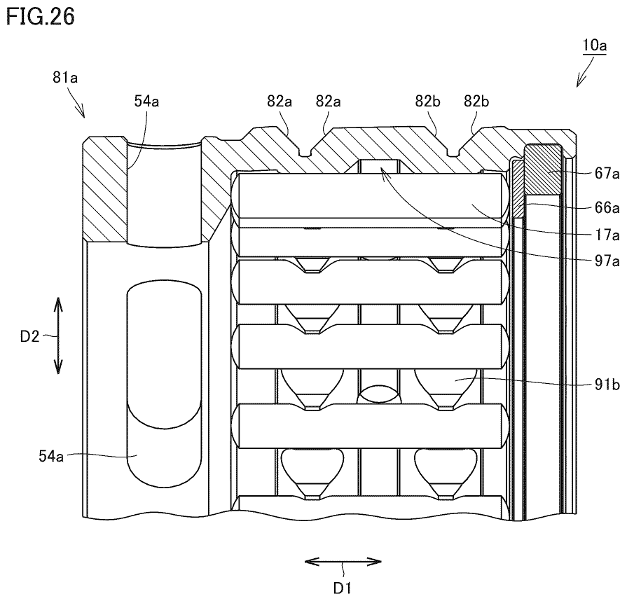

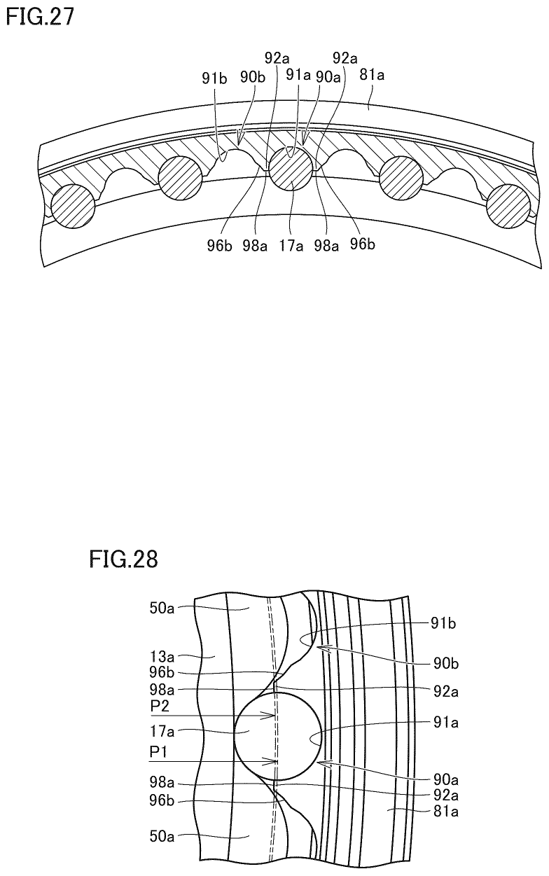

Then, a configuration of the second inner ring 81a will be described. FIGS. 24 and 25 are schematic perspective views of the second inner ring 81a. FIGS. 24 and 25 show the second inner ring 81a as seen in different directions. FIG. 26 is an enlarged schematic cross-sectional view illustrating a portion of the speed reducer 10a including the second inner ring 81a. FIG. 26 does not show some members. FIG. 27 is an enlarged schematic cross-sectional view illustrating a portion of the second inner ring 81a and one outer pin 17a. FIG. 28 is a further enlarged schematic view illustrating the portion of the second inner ring 81a and the outer pin 17a shown in FIG. 27. For facilitating understanding, FIGS. 24 through 28 also show the outer pin 17a.

With reference to FIGS. 24, 25, 26, 27, and 28, the second inner ring 81a is an annular member, and the outer peripheral surface of the second inner ring 81a has raceway surfaces 82a and 82a on which the cylindrical rollers 84a and 84b roll. From the viewpoint of weight reduction, the second inner ring 81a has elongated holes 54a each having the longitudinal directions in the circumferential directions, penetrating the second inner ring 81a in the radial directions, and arranged at regular intervals in the circumferential directions. The second inner ring 81a has a plurality of oil holes 58a each having the longitudinal directions in the circumferential directions, penetrating the second inner ring 81a in the radial directions, and arranged at regular intervals in the circumferential directions.

The raceway surfaces 82a and 82b are adjacent to each other in the axial directions. The raceway surfaces 82a and 82b are provided as a pair and arranged in the axial directions. Each of the raceway surfaces 82a and 82b is recessed radially inward in a V shape in cross section. The pair of the raceway surfaces 82a and 82b tilts at 45 degrees relative to the axial directions. The raceway surfaces 82a and 82b can accommodate the cylindrical rollers 84a and 84b in a space between the raceway surfaces 82a and 82b and the raceway surfaces 83a and 83b of the second outer ring 81b opposed to the raceway surfaces 82a and 82b in the radial directions. The cylindrical rollers 84a and 84b are arranged in the form of a crossed roller bearing, that is, the rolling axes of the cylindrical rollers 84a and 84b are alternately crossed at right angles to each other, between the raceway surfaces 82a and 82b and the raceway surfaces 83a and 83b.

Here, the inner peripheral surface of the second inner ring 81a has a plurality of outer pin housing grooves 90a that are recessed radially outward as seen the axial direction, arranged along the circumferential directions, and configured to house the outer pins 17a. A wall surface 91a constituting each of the outer pin housing grooves 90a includes a curved surface constituting a portion of an arc surface as seen in the axial direction. The wall surface 91a constituting each outer pin housing groove 90a is constituted by a so-called an R surface as seen in the axial direction. The inner peripheral surface of the second inner ring 81a also has slots 90b that are simply recessed radially outward as seen in the axial direction. The outer pin housing grooves 90a and the slots 90b are arranged alternately along the circumferential directions. That is, the outer pins 17a are arranged alternately in the circumferential directions in a groove-like recessed portion on a radially inner side of the second inner ring 81a.

The wall surface 91a along the circumferential directions constituting the outer pin housing grooves 90a have nails 92a and 92b that restrict radially inward movement of the outer pins 17a form the outer pin housing grooves 90a. In this embodiment, the second bearing 16a are crossed roller bearings arranged in multiple rows, specifically, two rows in the axial directions. In the inner peripheral surface of the second inner ring 81a, axial center portions 95a and 95b project radially inward relative to the axial end portions 93a, 93b, 94a, and 94b in each of the rows of the cylindrical rollers 84a and 84b (see especially FIG. 22). This configuration in which the axial center portions 95a and 95b project radially inward can make the thickness of a portion of the second inner ring 81a having the raceway surfaces 82a and 82b equal to other portions, such as the axial end portions 93a, 93b, 94a, and 94b. This can suppress a decrease in rigidity of a portion having the nails 92a and 92b. The nails 92a and 92b are located on the axial center portions 95a and 95b. An oil sump 97a in which lubricating oil is accumulated is formed between the axial center portions 95a and 95b in the axial directions.

As seen in the axial direction, a pitch circle diameter (PCD) of the outer pins 17a is larger than a diameter of an imaginary circle connecting the positions of the nails 92a in the circumferential directions. Specifically, as seen suppose a pitch circle diameter corresponding to an imaginary circle connecting the rotation centers of the outer pins 17a is a diameter P1 and the diameter of the imaginary circle connecting the positions of the nails 92a in the circumferential directions is a diameter P2, the diameter P1 is larger than the diameter P2. The inner diameter surface of each of the nails 92a is formed in a curved shape with a single curvature radius from the center of the imaginary circle connecting the positions of the nails 92a in the circumferential directions. A curvature radius R in this case is represented as a diameter P2/2.

A wall surface 91b in the circumferential directions not constituting each outer pin housing groove 90a has a relief portion 96b that is recessed radially outward to reduce the thickness. The relief portions 96b are located such that the external teeth 50a and 50b of the cycloid gears 13a and 13b do not interfere with the relief portions 96b. The wall surface constituting each of the relief portions 96b has an arc shape as seen in the axial direction.

Next, an example of a method for assembling the speed reducer 10a described above will be described. First, the input shaft 11a and the first bearings 31a and 31b are prepared as described above to assemble the input unit 12a. In this assembly, the first outer rings 33a and 33b are press fitted in the first through holes 51a and 51b of the cycloid gears 13a and 13b beforehand such that the assembly is performed in a state where the cycloid gears 13a and 13b are attached to the input unit 12a. Thereafter, the inner pins 14a are placed in the second through holes 52a and 52b of the cycloid gears 13a and 13b, and the inner pin holder 15a is attached to the input unit 12a in the axial directions. The outer pins 17a are housed in the outer pin housing grooves 90a formed on the inner peripheral surface of the second inner ring 81a. At this time, the outer pins 17a are fitted in the outer pin housing grooves 90a from the rear side (side where the outer pin guide plate 66a and the retaining ring 67a are to be located) of the second inner ring 81a. Thereafter, the outer pin guide plate 66a and the retaining ring 67a are attached to the second inner ring 81a. Then, the second outer ring 81b is attached to the radially outer side of the second inner ring 81a. Subsequently, the plurality of cylindrical rollers 84a and 84b are alternately inserted through the insertion holes 44a and 44b such that the rolling axes intersect perpendicularly to each other, and after all the cylindrical rollers 84a and 84b have been inserted, the spacer 45a is inserted. Thereafter, the lids 46a and 46b are fitted in the insertion holes 44a and 44b, and the lid fixing pins 47b are attached to fix the lids 46a and 46b. Then, the input unit 12a to which the cycloid gears 13a and 13b, the inner pins 14a, and the inner pin holder 15a are attached, is attached to the radially inner side of the second inner ring 81a housing the outer pins 17a. At this time, even when the second inner ring 81a is tilted with the front side (side opposite to the rear side in the axial directions) facing upward, since the nails 92a on the wall surface constituting the outer pin housing grooves 90a prevent the outer pins 17a in the outer pin housing grooves 90a from falling off from the rear side. In this manner, the cycloid gears 13a and 13b and the input unit 12a are attached to the radially inner side of the second inner ring 81a, thereby assembling the speed reducer 10a.

Next, operation of the speed reducer 10a in the first embodiment of the present disclosure will be described. When the input shaft 11a rotates (spins) at high speed, the eccentric first inner rings 32a and 32b of the first bearings 31a and 31b rotate (spin) accordingly. Here, in the cycloid gears 13a and 13b in which the first outer rings 33a and 33b of the first bearings 31a and 31b are press fitted in the first through holes 51a and 51b, the inner pins 14a are located in the second through holes 52a and 52b. Since the shanks 61a of the inner pins 14a are press fitted in the inner pin holder 15a as a fixing portion, the inner pins 14a themselves do not rotate. Thus, the cycloid gears 13a and 13b do not revolve, and spin, shifting by one pitch at each turn of the input shaft 11a while maintaining eccentric motion. With the spinning of the cycloid gears 13a and 13b by one pitch, the outer pins 17a meshing with the external teeth 50a and 50b of the cycloid gears 13a and 13b revolve while spinning in the outer pin housing grooves 90a formed on the inner peripheral surface of the second inner ring 81a. With the revolution of the outer pins 17a housed in the outer pin housing grooves 90a, the wall surface on the inner circumferential side of the second inner ring 81a constituting the outer pin housing grooves 90a is pushed in the rotation direction (spinning direction), and the second inner ring 81a spins at low speed, that is, spins by one pitch. In this manner, the rotation speed input from the input shaft 11a is reduced and output from the second inner ring 81a. In this case, the direction of rotation of the input shaft 11a is the same as the direction of rotation of the second inner ring 81a. In this embodiment, since the number of the outer pins 17a is 36 and the number of the external teeth 50a and 50b of the cycloid gears 13a and 13b is 35, the rotation speed of the second inner ring 81a as the output shaft is 1/36 of the rotation speed of the input shaft 11a. That is, in this embodiment, one pitch corresponds to 1/36 of the circumference.

In the speed reducer 10a of the present disclosure, the inner peripheral surface of the second inner ring 81 a has the plurality of outer pin housing grooves 90a that are recessed radially outward in the axial directions, are arranged along the circumferential directions, and houses the outer pins 17a. The wall surface 91a along the circumferential directions constituting the outer pin housing grooves 90a have the nails 92a and 92b that restrict radially inward movement of the outer pins 17a form the outer pin housing grooves 90a. With this configuration, in rotation of the cycloid gears 13a and 13b during operation of the speed reducer 10a, even when a gap between the cycloid gears 13a and 13b and the outer pins 17a is enlarged, the nails 92a and 92b restrict falling of the outer pins 17a radially inward. Then, the posture of the outer pins 17a in the outer pin housing grooves 90a is stabilized so that rattles of the outer pins 17a can be thereby reduced. Accordingly, even when a gap between the cycloid gears 13a and 13b and the outer pins 17a is enlarged, snagging between the cycloid gears 13a and 13b and the outer pins 17a is reduced so that rotation of the outer pins 17a housed in the outer pin housing grooves 90a and rotation of the cycloid gears 13a and 13b thereby become smoother. As a result, occurrence of rotation noise during operation of the speed reducer 10a is reduced, and quietness is enhanced. In this case, rotational smoothness of the rotating parts relative to the fixed parts of the speed reducer 10a can be enhanced.

In the second inner ring 81a including the nails 92a and 92b described above, the outer pins 17a can be housed and held in the outer pin housing grooves 90a beforehand. In this case, even when the second inner ring 81a is tilted with the front side facing upward in a state where the outer pins 17a are housed in the outer pin housing grooves 90a, falling off of the outer pins 17a in the outer pin housing grooves 90a from the rear side can be prevented. Accordingly, assembly can be performed by tilting the second inner ring 81a with the outer pins 17a placed in the outer pin housing grooves 90a beforehand, and workability in assembling the speed reducer 10a can be enhanced.

In this embodiment, the wall surface 91b in the circumferential directions not constituting the outer pin housing grooves 90a has the relief portion 96b that is recessed radially outward to reduce the thickness. This reduces the probability of interference between the external teeth 50a and 50b of the cycloid gears 13a and 13b and the inner peripheral surface of the second inner ring 81a during rotation of the cycloid gears 13a and 13b. Accordingly, the cycloid gears 13a and 13b rotate more smoothly, and quietness is enhanced.

In this embodiment, as seen in the axial direction, the pitch circle diameter of the outer pins 17a is larger than the diameter of the imaginary circle connecting the positions of the nails 92a and 92b in the circumferential directions. This further ensures restriction of radially inward movement of the outer pins 17a by the nails 92a and 92b.

In this embodiment, on the inner peripheral surface of the second inner ring 81a, the axial center portions 95a and 95b project radially inward relative to the axial end portions 93a, 93b, 94a, and 94b. The axial center portions 95a and 95b have the nails 92a and 92b. Thus, the contact area between the nails 92a and 92b and the outer pins 17a is reduced so that smooth rotation of the outer pins 17a can be ensured. In the axial center portions 95a and 95b, the outer pins 17a are guided by the nails 92a and 92b. This reduces the risk of tilting of the outer pins 17a in the axial directions, and more stable rotation can be ensured.

In this embodiment, inner peripheral surfaces 98a and 98b of the nails 92a and 92b are each formed in a curved shape with a single curvature radius from the center of the imaginary circle connecting the positions of the nails 92a and 92b in the circumferential directions. Thus, during rotation of the cycloid gears 13a and 13b, the external teeth 50a and 50b of the cycloid gears 13a and 13b can easily pass over the positions where the nails 92a and 92b are provided. Accordingly, the cycloid gears 13a and 13b rotate more smoothly, and quietness is enhanced.

In this embodiment, the second bearing 16a includes a multi-row crossed roller bearing in which the cylindrical rollers 84a and 84b are arranged in multiple rows in the axial directions. Thus, loads applied in various directions can be appropriately received by the second bearing 16a with a compact configuration. Accordingly, the size of the speed reducer 10a can be easily reduced. In addition, the rotation center axis of the crossed roller bearing and the rotation center axes of components constituting of the speed reducer mechanism can be easily placed on the same plane, thus making it possible to reduce torsion between the input shaft 11a and the second inner ring 81a as an output shaft caused by a load torque.

In this embodiment, in the inner peripheral surface of the second inner ring 81a, the axial center portions 95a and 95b project radially inward relative to the axial end portions 93a, 93b, 94a, and 94b in each of the rows of the cylindrical rollers 84a and 84b. The nails 92a and 92b are located on the axial center portions 95a and 95b. Thus, it is possible to bring the nails 92a and 92b on the axial center portions 95a and 95b corresponding to the cylindrical rollers 84a and 84b in each row into contact with the outer pins 17a. Then, the outer pins 17a are guided by the plurality of nails 92a and 92b in the axial directions so that the risk of tilting of the outer pins 17a in the axial directions can be further reduced. As a result, more stable rotation can be ensured.

Here, in regard to the input shaft 11a included in the input unit 12a and the first bearings 31a and 31b, specifically, the input shaft 11a and the eccentric first inner rings 32a and 32b included in the first bearings 31a and 31b, the first inner rings 32a and 32b need to be rotated together with the input shaft 11a, and thus, are possibly formed integrally with the input shaft 11a. In this case, the input shaft 11a and the first inner rings 32a and 32b can be possibly formed from rod-shaped members of the same metal by shaving, for example. However, in this structure, functions required for the components, specifically, the input shaft 11a and the first inner rings 32a and 32b, cannot be made different. For this reason, this structure is not preferable.

In the speed reducer 10a of the present disclosure, the first inner rings 32a and 32b are provided separately from the input shaft 11a. The input unit 12a includes the movement restrictors 40a and 40b that restrict movement of the first inner rings 32a and 32b relative to the input shaft 11a in the circumferential directions. This configuration enables the input shaft 11a and the first inner rings 32a and 32b that are components of the input unit 12a to be made of different materials. Then, a material suitable for the function required for each component can be selected to assemble the input unit 12a. In this case, since the input unit 12a includes the movement restrictor 40a that restricts movement of the first inner rings 32a and 32b relative to the input shaft 11a in the circumferential directions, the first inner rings 32a and 32b can be reliably positioned in the circumferential directions, and the first inner rings 32a and 32b can be reliably rotated together with the input shaft 11a. Accordingly, stable operation of the speed reducer 10a can be ensured. In addition, since the components are made of separate members, accuracy in grinding of, for example, the eccentric first inner rings 32a and 32b can be easily increased so that productivity can be thereby enhanced. Further, since the first inner rings 32a and 32b are separate members, a change of eccentricity of the first inner rings 32a and 32b and sorting of accuracy, which would be difficult in an integrated-type input unit 12a, can be easily performed. That is, the first inner rings 32a and 32b fabricated in accordance with requirements can be selected and combined with the separately fabricated input shaft 11a to produce the input unit 12a that meets requirements. Since the input shaft 11a is also a separate member, it becomes easier to perform additional machining on the input shaft 11a or incorporate design changes according to an application. Specifically, a material exemplified by a light metal, such as aluminum, or a resin is employed as a material for the input shaft 11a that is a component constituting the input unit 12a in consideration of weight reduction and torque resistance, whereas bearing steel is employed as a material for the first inner rings 32a and 32b from the viewpoint of enhancement of durability. The foregoing speed reducer 10a can ensure stable operation with enhanced productivity.

In this embodiment, the movement restrictors 40a and 40b restrict movement of the first inner rings 32a and 32b relative to the input shaft 11a in the axial directions. Thus, the first inner rings 32a and 32b are reliably positioned in the axial directions, thereby ensuring more stable operation of the speed reducer 10a.

In this embodiment, the movement restrictors 40a and 40b include the first keyways 41a and 41b recessed from the outer peripheral surface of the input shaft 11a, the second keyways 42a and 42b recessed from the inner peripheral surfaces of the first inner rings 32a and 32b, and the key members 43a and 43b fitted in both the first keyways 41a and 41b and the second keyways 42a and 42b. Accordingly, by fitting the key members 43a and 43b in the first keyways 41a and 41b and the second keyways 42a and 42b, the first inner rings 32a and 32b can be reliably positioned in the circumferential directions.

In this embodiment, the first keyways 41a and 41b extend in the axial directions on a portion of the outer peripheral surface of the input shaft 11a in the circumferential directions. The second keyways 42a and 42b are located at positions facing the first keyways 41a and 41b. The key members 43a and 43b have rod shapes extending in the axial directions. Accordingly, the first inner rings 32a and 32b can be more reliably positioned in the circumferential directions with a relatively simple structure.

In this embodiment, the flanges 37a and 37b projecting radially outward are provided at least on end portions of the first inner rings 32a and 32b on one side in the axial directions. Thus, it is possible to restrict movement of the retainers 35a and 35b included in the needle cages 36a and 36b in the axial directions by using the flanges 37a and 37b. As a result, more stable operation of the speed reducer 10a can be ensured.

In this embodiment, the input unit 12a includes the guide ring 49a provided separately from the input shaft 11a and the first inner rings 32a and 32b, having the disc shape, located at least on one side of the first inner rings 32a and 32b in the axial directions, and projecting radially outward relative to the raceway surfaces of the first inner rings 32a and 32b. Thus, it is also possible to restrict movement of the retainers 35a and 35b included in the needle cages 36a and 36b in the axial directions by using the guide ring 49a. As a result, more stable operation of the speed reducer 10a can be ensured. Similarly, a material for the guide ring 49a included in the input unit 12a can be selected independently of materials for other components, and may be a resin such as PEEK containing fibers or a light metal such as aluminum, for example.

In this embodiment, the pair of first bearings 31a and 31b is disposed in the axial directions. The first inner rings 32a and 32b as a pair included in the pair of first bearings 31a and 31b, respectively, are disposed with a 180-degree phase shift in the circumferential directions. Thus, influence of the eccentric first inner rings 32a and 32b during rotation of the input shaft 11a can be reduced, and more stable rotation of the input shaft 11a can be ensured.

In this embodiment, the first inner rings 32a and 32b are fixed to the input shaft 11a by interference fitting. This also restricts movement of the first inner rings 32a and 32b relative to the input shaft 11a in the axial directions.

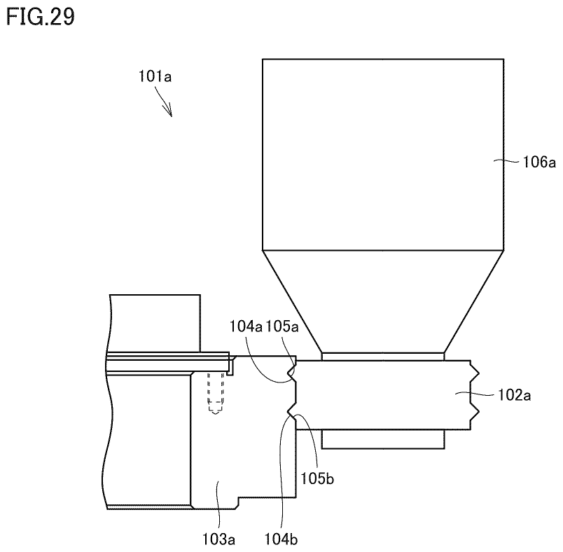

An example of a method for fabricating the second inner ring 81a in the members constituting the speed reducer 10a will be briefly described. First, an annular metal member is prepared and subjected to a treatment such as shaving to have an outer diameter shape of the second inner ring 81a. Then, grinding is performed on the raceway surfaces 82a and 82b that require smoothness. FIG. 29 is a schematic view illustrating an example of a cylindrical grinder used for grinding the second inner ring 81a. With reference to FIG. 29, a cylindrical grinder 101a includes a grindstone part 102a and a rotary dresser 103a. The cylindrical grindstone part 102a for grinding an object includes projections 104a and 104b projecting radially outward and corresponding to the raceway surfaces 82a and 82b of the second inner ring 81a. An interval between the projections 104a and 104b is substantially equal to an interval between the raceway surfaces 82a and 82b. The rotary dresser 103a having a cylindrical portion includes recesses 105a and 105b that are recessed radially inward and correspond to the inner peripheral surface of the second inner ring 81a.

With this cylindrical grinder 101a, the raceway surfaces 82a and 82b of the second inner ring 81a are ground. Specifically, although not shown, the second inner ring 81a is attached to the radially outer side of the rotary dresser 103a. In a state where the projections 104a and 104b are pushed against the raceway surfaces 82a and 82b from the radially outer side of the second inner ring 81a, the grindstone part 102a attached to the spindle 106a is rotated to grind the raceway surfaces 82a and 82b.

In this manner, even when the spindle 106a thermally expands during grinding, the risk of shift of the interval between the raceway surfaces 82a and 82b can be significantly reduced. Specifically, if the raceway surfaces 82a and 82b are ground one by one, grinding is performed with a shift of the interval between the raceway surfaces 82a and 82b because of thermal expansion of the spindle 106a during grinding, machining errors of the cylindrical grinder 101a, and other reasons, resulting in degradation of dimensional accuracy. On the other hand, the fabrication method described above can significantly reduce shifts of the interval and depth of the raceway surfaces 82a and 82b. Accordingly, the second inner ring 81a can be accurately fabricated. In addition, since the raceway surfaces 82a and 82b can be ground at a time, lead time can be shortened, as compared to the case where the raceway surfaces 82a and 82b are ground one by one. A similar configuration is also employed for the raceway surfaces 83a and 83b of the second outer ring 81b, and the raceway surfaces 83a and 83b are ground at a time. Then, dimensional accuracy can be increased and the lead time can be shortened.

### OTHER EMBODIMENTS

In the embodiment described above, the pair of cycloid gears is arranged in the axial directions. However, the present disclosure is not limited to this example, and the speed reducer may include one cycloid gear.

In the embodiment described above, the lids are provided at the same positions in the circumferential directions as the positions of the multi-row crossed roller bearings. However, the present disclosure is not limited to this example, and the lids may be provided with a shift in the circumferential directions.

The embodiment described above employs the multi-row crossed roller bearing. However, the present disclosure is not limited to this example, a multi-row angular bearing may be employed. At least one of the first bearing or the second bearing may employ another bearing, for example, a combination of a radial bearing and an axial bearing. A plain bearing may also be employed.

In the embodiment described above, in the crossed roller bearing, a gap between the cylindrical rollers is adjusted with the spacer. However, the present disclosure is not limited to this example, the crossed roller bearing may include a retainer retaining cylindrical rollers or may include a separator located between cylindrical rollers.

It should be understood that the embodiment disclosed here is illustrative and non-restrictive in every respect. The scope of the present invention is defined by the claims and is intended to include any modifications within the scope and meaning equivalent to the claims.

### DESCRIPTION OF REFERENCE NUMERALS

10a speed reducer, 11a input shaft, 12a input unit, 13a, 13b cycloid gear, 14a inner pin, 15a inner pin holder, 16a second bearing, 17a outer pin, 21a first axial end, 21b second axial end, 23a axial through hole, 24a axial inner peripheral surface keyway, 25a, 98a inner peripheral surface, 25b outer peripheral surface, 26a, 27a bolt, 29a first input shaft bearing, 29b second input shaft bearing, 31a, 31b first bearing, 32a, 32b first inner ring, 33a, 33b first outer ring, 34a, 34b needle roller, 35a, 35b retainer, 36a, 36b needle cage, 37a, 37b flange, 40a, 40b movement restrictor, 41a, 41b first keyway, 42a, 42b second keyway, 43a, 43b key member, 44a, 44b insertion hole, 45a spacer, 46a, 46b lid, 47b lid fixing pin, 48a, 48b collar, 49a guide ring, 50a, 50b external teeth, 51a, 51b first through hole, 52a, 52b second through hole, 53a, 53b third through hole, 54a, 55a elongated hole, 58a, 86a oil hole, 61a shank, 62a, 62b inner pin outer ring, 63a roller, 64a, 64b, 64c, 64d, 65a, 65b, 65c, 65d thrust washer, 66a outer pin guide plate, 67a retaining ring, 71a first holder portion, 71b second holder portion, 72a plate portion, 72b first portion, 73a support column, 73b second portion, 74a, 74b press-fitting hole, 75a, 75b, 77a recessed groove, 76a screw hole, 76b through hole, 78a, 78b step, 79b notch, 81a second inner ring, 81b second outer ring, 82a, 82b, 83a, 83b raceway surface, 84a, 84b cylindrical roller, 85a, 85b oil groove, 87a annular groove, 89b bolt hole, 90a outer pin housing groove, 90b slot, 91a, 91b wall surface, 92a, 92b nail, 93a, 93b, 94a, 94b end portion, 95a, 95b center portion, 96b relief portion, 97a oil sump, 101a cylindrical grinder, 102a grindstone part, 103a rotary dresser, 104a, 104b projection, 105a, 105b recess, 106a spindle.

1. A speed reducer comprising:
an input unit including an input shaft and a first bearing, the first bearing including an eccentric first inner ring that rotates together with the input shaft;
a cycloid gear located radially outward of the first bearing and including a plurality of external teeth arranged on an outer peripheral surface along circumferential directions, the cycloid gear including a first through hole the input unit penetrates and a plurality of second through holes located radially outward of the first through hole and arranged with intervals in the circumferential directions;
a plurality of inner pins penetrating the second through holes in axial directions;
an inner pin holder holding end portions of the plurality of inner pins in the axial directions and surrounding an outer peripheral surface of the input unit;
a second bearing located radially outward of the cycloid gear, and including a second inner ring that is an output shaft, a second outer ring located radially outward of the second inner ring, and a rolling body located between the second inner ring and the second outer ring; and
a plurality of outer pins held on a radially inner surface of the second inner ring and meshing with the external teeth of the cycloid gear, wherein
the first inner ring is provided separately from the input shaft, and
the input unit includes a movement restrictor that restricts movement of the first inner ring relative to the input shaft in the circumferential directions.

2. The speed reducer according to claim 1, wherein the movement restrictor restricts movement of the first inner ring relative to the input shaft in the axial directions.

3. The speed reducer according to claim 1, wherein
the movement restrictor includes
a first keyway recessed from an outer peripheral surface of the input shaft,
a second keyway recessed from an inner peripheral surface of the first inner ring, and
a key member fitted in both the first keyway and the second keyway.

4. The speed reducer according to claim 3, wherein
the first keyway extends in the axial directions in a portion of the outer peripheral surface of the input shaft in the circumferential directions,
the second keyway is located at a position facing the first keyway, and
the key member has a rod shape extending in the axial directions.

5. The speed reducer according to claim 1, wherein at least an end portion of the first inner ring on one side in the axial directions includes a flange projecting radially outward.

6. The speed reducer according to claim 1, wherein the input unit further includes a guide ring that is provided separately from the input shaft and the first inner ring, has a disc shape, is located at least on one side of the first inner ring in the axial directions, and projects radially outward relative to a raceway surface of the first inner ring.

7. The speed reducer according to claim 1, wherein
the first bearing comprises a pair of first bearings arranged in the axial directions, and
the first inner ring comprises a pair of first inner rings included in the pair of first bearings, and the pair of first inner rings are arranged with a 180-degree phase shift in the circumferential directions.

8. The speed reducer according to claim 1, wherein the first inner ring is fixed to the input shaft by interference fitting.

9. The speed reducer according to claim 2, wherein
the movement restrictor includes
a first keyway recessed from an outer peripheral surface of the input shaft,
a second keyway recessed from an inner peripheral surface of the first inner ring, and
a key member fitted in both the first keyway and the second keyway.

10. The speed reducer according to claim 9, wherein
the first keyway extends in the axial directions in a portion of the outer peripheral surface of the input shaft in the circumferential directions,
the second keyway is located at a position facing the first keyway, and
the key member has a rod shape extending in the axial directions.

11. The speed reducer according to claim 2, wherein at least an end portion of the first inner ring on one side in the axial directions includes a flange projecting radially outward.

12. The speed reducer according to claim 2, wherein the input unit further includes a guide ring that is provided separately from the input shaft and the first inner ring, has a disc shape, is located at least on one side of the first inner ring in the axial directions, and projects radially outward relative to a raceway surface of the first inner ring.

13. The speed reducer according to claim 2, wherein
the first bearing comprises a pair of first bearings arranged in the axial directions, and
the first inner ring comprises a pair of first inner rings included in the pair of first bearings, and the pair of first inner rings are arranged with a 180-degree phase shift in the circumferential directions.

14. The speed reducer according to claim 2, wherein the first inner ring is fixed to the input shaft by interference fitting.
